(19) United States
(12) Patent Application Publication
(10) Pub. No.: US 2002/0023991 A1
(43) Pub. Date: Feb. 28, 2002

(54) Channel member

(75) Inventors: Sydney James Harris, Hampshire (GB); Andrew Charles Woolnough, Kent (GB)

Correspondence Address: Don W. Bulson, Esq., Renner, Otto, Boisselle & Sklar, LLP, 19th Floor, 1621 Euclid Avenue, Cleveland, OH, 44115, US

(73) Assignee: EML Limited

(21) Appl. No.: 09/933,966

(22) Filed: Aug. 21, 2001

(30) Foreign Application Priority Data
Aug. 22, 2000 (GB) 0020532.8

(51) Int. Cl. A47K 1/00; F16L 3/08

(52) U.S. Cl. 248/304; 248/300

(57) ABSTRACT

A channel member 10 is open on one side 12 to define a socket 14 for receiving a retail accessory (not shown). The exterior of one or more sidewalls 16, 18 of the channel member 10 includes a resiliently deformable ribs 20 protruding therefrom.

The ribs 20 permit retention of the channel member 10 in a further channel 34 formed in a shelf 40.

The invention relates to a channel member that is suitable for engagement in e.g. a shelf front or slat wall channel.

In the retail and display industries, it is common to attach items such as, but not limited to, point of sale cardholders, dividers, brackets, leaflet dispensers, sample dispensers, wobblers, shelves, poster holders and pendants (herein referred to as “retail or display accessories”) to shelves, slat walls or other structures e.g. in order to organise displayed items; to encourage consumers to purchase the items; to provide promotional samples and/or information; and to provide point of sale dispensing of further products associated with goods or shelves. An example of the last mentioned use of such items is the dispensing of packs of batteries adjacent a display of electrically powered toys in a toy store.

One method of displaying point of sale information is disclosed in U.S. Pat. No. 4,557,064.

U.S. Pat. No. 4,557,064 discloses a plastic cardholder for receiving and gripping a card for display purposes. The holder is an elongate channel member that is open along one side to permit insertion of a display card. The opposed, inner walls of the channel each include a plurality of flexible, resiliently deformable fins that extend into the open space between the walls. The fins flex in order to grip a display card inserted into the holder.

The cardholder of U.S. Pat. No. 4,557,064 may be secured in position on a shelf by adhesive, or clips. The cardholder may also have ledges extending outwardly from the exterior of one of the walls for engagement with mutually opposed lips provided on a shelf front, or a similar ledge that engages between upper and lower boxes.

The cardholder of U.S. Pat. No. 4,557,064 is always located on an external surface of either the shelf or other article to which it is secured. Consequently its attachment member is always visible, which can be unsightly. It also can interfere with goods displays on the shelves.

The cardholder secured in this way is vulnerable to being knocked off the shelf or article. Also, the cardholder may be damaged by, or may cause damage to, the clothes of people brushing past the shelf.

According to a first aspect of the invention there is provided a channel member as claimed in Claim 1.

The resiliently deformable ribs allow the channel member to be push-fittingly engaged within a shelf front channel.

When the channel member is engaged within a shelf front channel, it is hidden from view and does not impinge on, or detract from, retail displays arranged on the shelf. Also, because the channel member is hidden from view, and is not located on a surface of the shelf, it is less likely to be knocked out of engagement with the shelf, or subjected to damage.

In an embodiment of the invention, the ribs include at least two mutually parallel barbs protruding from each of a pair of said walls.

One or more of the sidewalls of the channel member may be resiliently deflectable, one or more of said sidewalls including on an inwardly facing surface a formation that is co-operable with a correspondingly shaped formation formed on a retail or display accessory to define a detent for retaining the retail accessory in the socket.

This arrangement provides means by which a retail or display accessory provided with a correspondingly shaped formation can be detachably secured within the socket of the channel member. It also means that when the channel member is engaged within a shelf front channel, the retail or display accessory cannot be easily pulled out of the socket if someone pulls the accessory away from the shelf.

In a preferred embodiment of the invention, two said sidewalls are resiliently deflectable and the formation on each said surface is a groove recessed relative to the remainder of the surface and defining a shoulder facing the bottom of the channel to define the detent.

In such embodiments, the grooves may be mutually parallel.

The channel member and ribs may be co-extruded respectively from two different grades of polyvinylchloride (PVC).

This simplifies the manufacture of the channel member.

According to a second aspect of the invention, there is provided a retail or display accessory assembly as claimed in Claim 7.

According to a third aspect of the invention, there is provided a retail or display accessory assembly as claimed in Claim 8.

In either of the second or third aspects of the invention, the retail or display accessory may be, but is not limited to, a point of sale cardholder, divider, bracket, leaflet dispenser, sample dispenser, wobbler, shelf, poster holder or pendant.

According to a fourth aspect of the invention, there is provided a retail or display accessory as claimed in Claim 10.

Preferred embodiments of the invention will now be described, by way of non-limiting examples, with reference to the following figures in which:

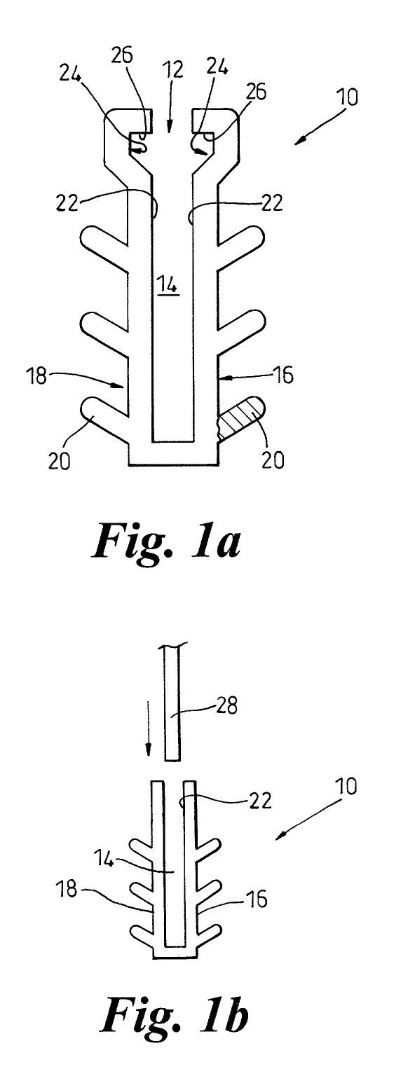

FIG. 1a is a cross-sectional view of a channel member according to an embodiment of the invention;

FIG. 1b is a cross-sectional view of a channel member according to another embodiment of the invention;

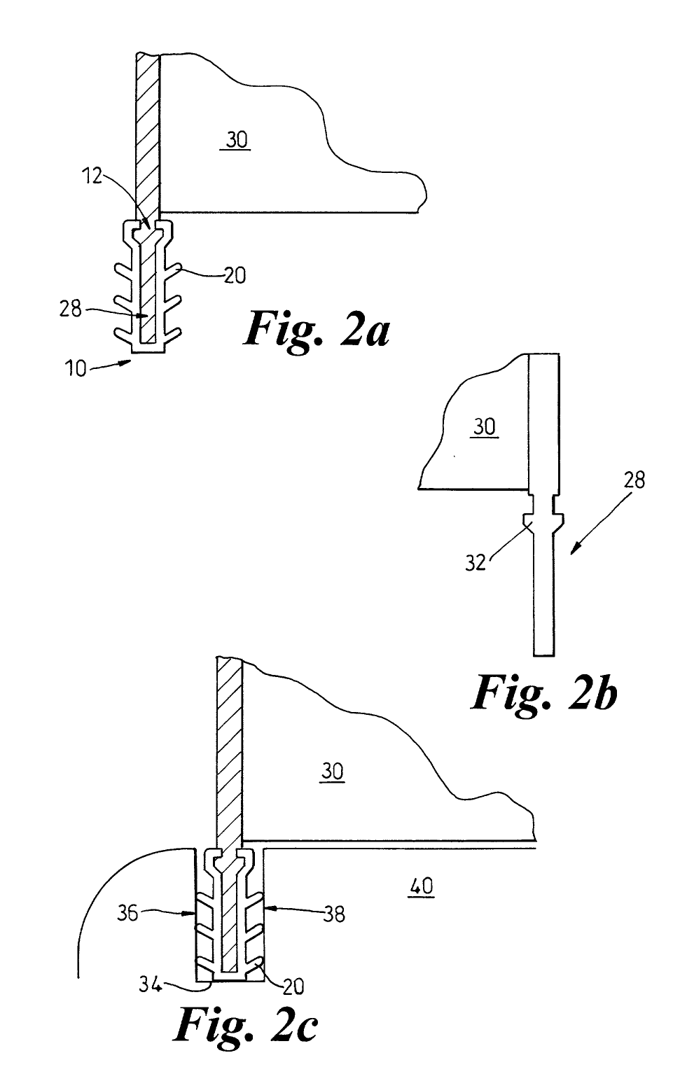

FIGS. 2a to 2c show insertion of a retail or display accessory into the channel member of FIG. 1a to define an accessory assembly and insertion of the assembly into a shelf front channel;

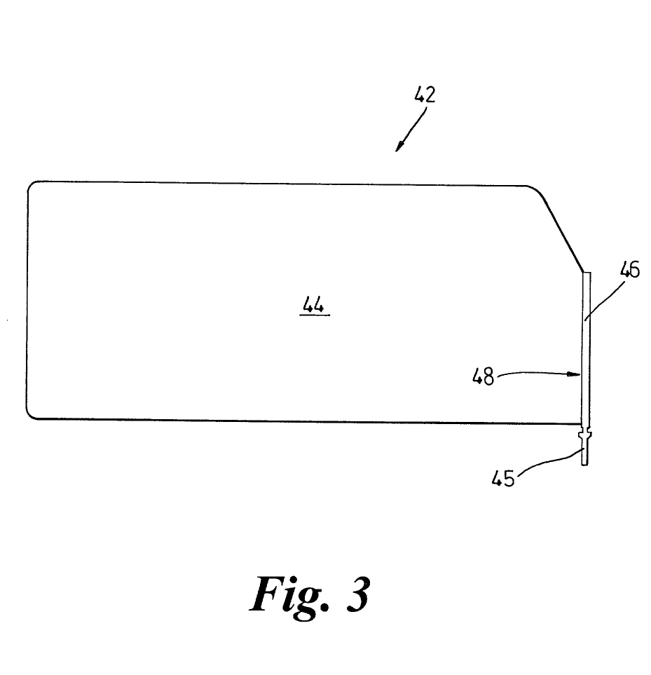

FIG. 3 shows a divider according to the invention;

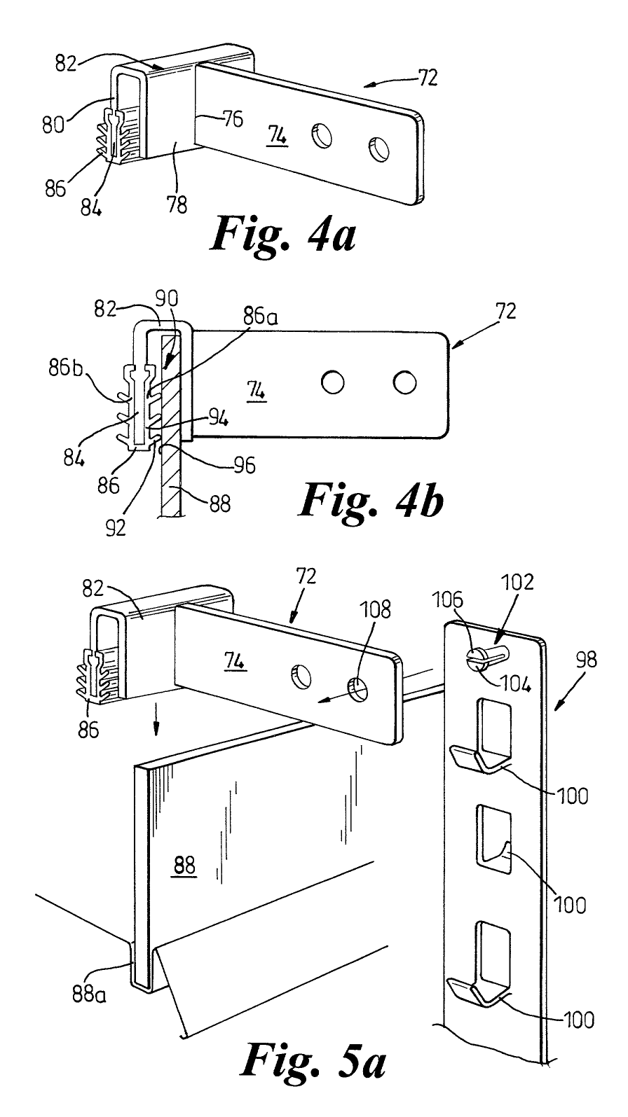

FIGS. 4-6 show an assembly, according to the invention, for suspending a further retail or display accessory;

FIG. 7 shows a divider assembly, according to the invention, in conjunction with another kind of retail display;

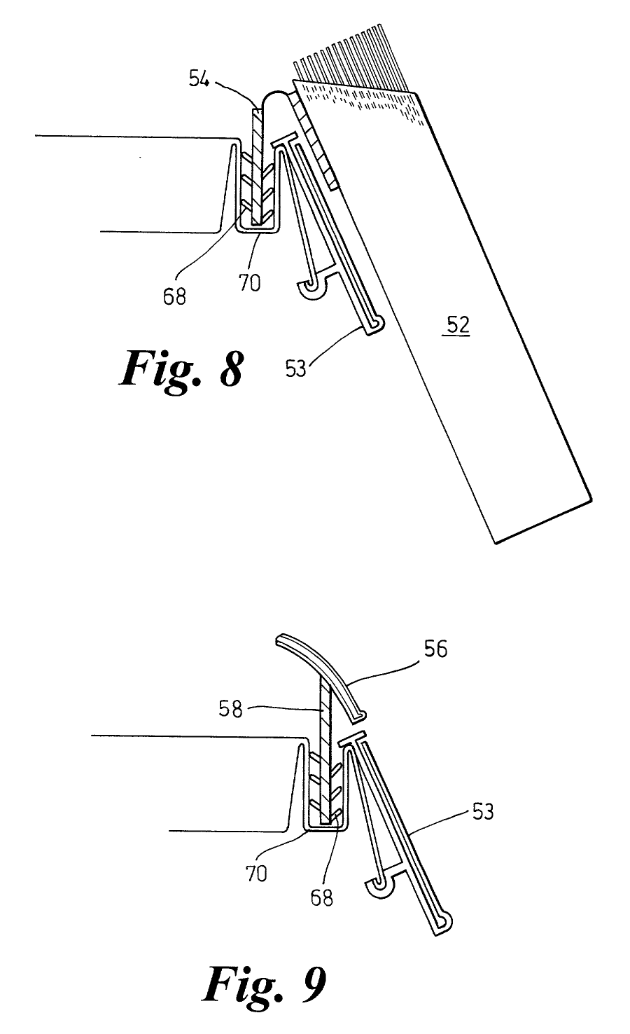

FIGS. 8 and 9 respectively show a leaflet dispenser and a shelf front according to the invention;

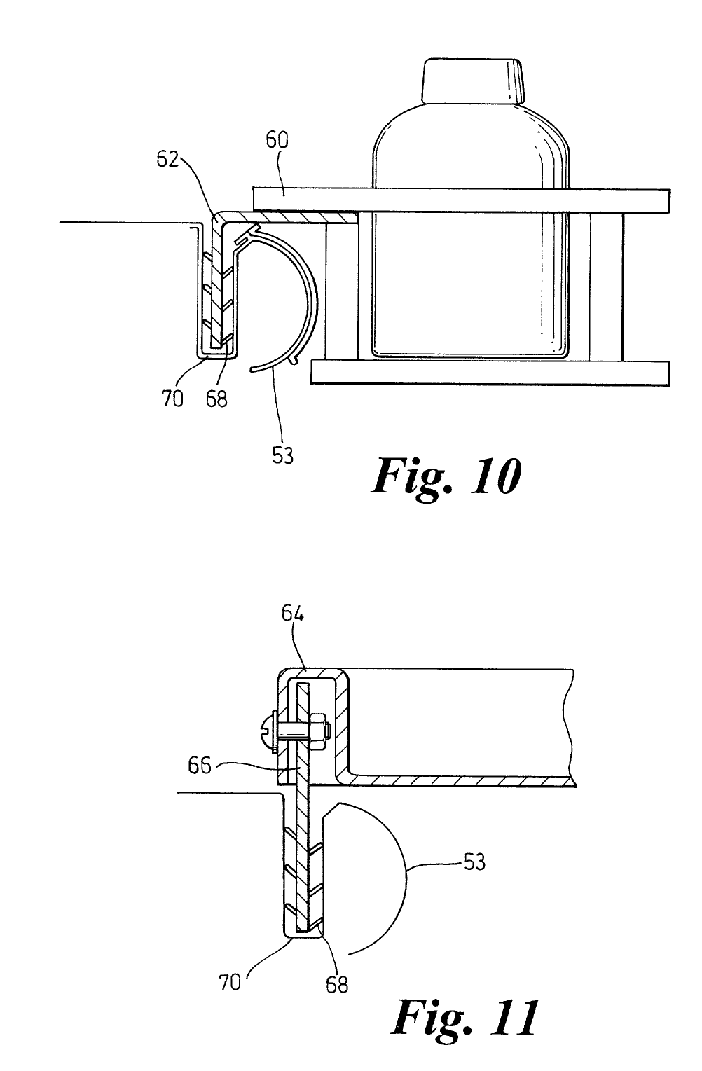

FIGS. 10 and 11 show a shelf extension assembly according to the invention;

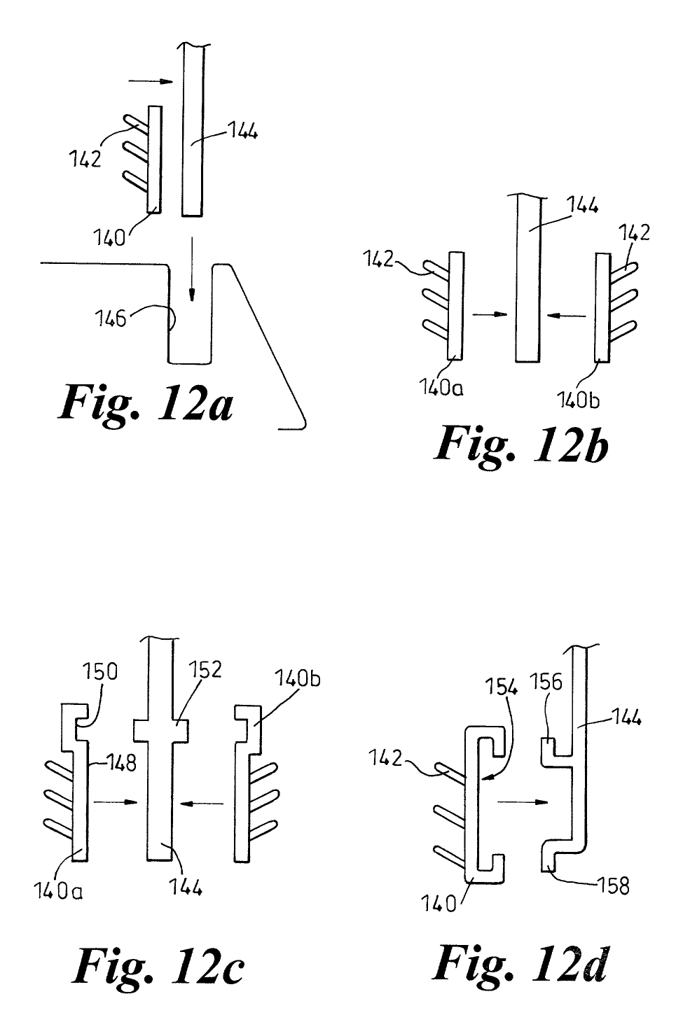

FIGS. 12a-12d show assemblies, according to the invention, for securing a retail or display accessory in a shelf front channel;

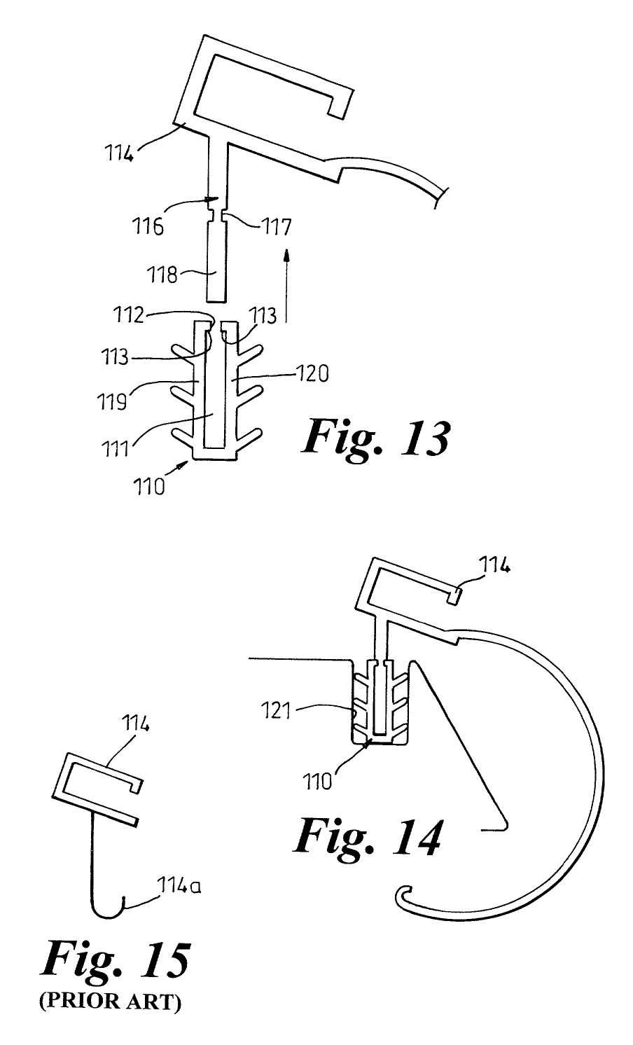

FIGS. 13, 14 and 16 to 20 show use of a channel member according to the invention to secure retail and/or display items to a slat wall;

FIG. 15 shows a prior art arrangement; and

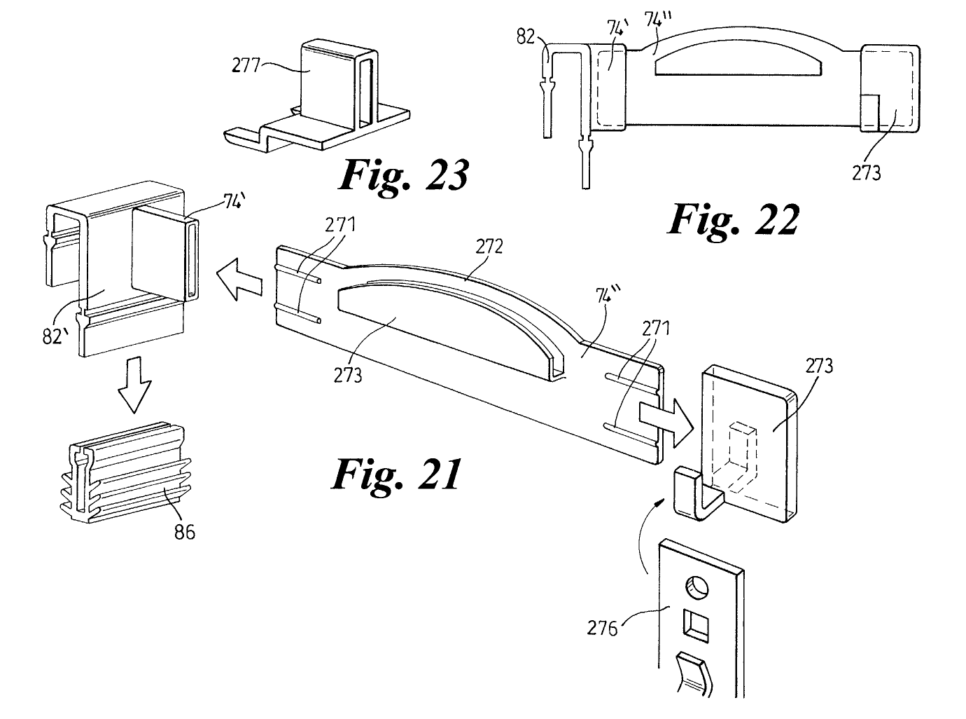

FIGS. 21 to 23 show another embodiment of the invention.

FIG. 1a is an end elevational, partly sectioned view of an elongate, U-section channel member 10 according to an embodiment of the invention.

The channel member 10 is open along one of its longer sides 12, defining a socket 14 for receiving a retail or display accessory (not shown in FIG. 1a).

The exterior of each of two opposite sidewalls 16, 18 of the channel member 10 includes at least two resiliently deformable, and mutually parallel, barbs 20 protruding therefrom. Each of the barbs 20 extends at an angle to its associated sidewall 16, 18, towards the open side 12 of the channel member 10. The purpose of the barbs is to permit retention of the channel member 10, in a manner described in more detail below, in a recess formed in a further structure. Although each barb 20 is in the preferred embodiment shown parallel sided and round ended, many other shapes of barb are possible within the scope of the invention.

Each of the sidewalls 16, 18 is resiliently deflectable, and includes, on an inwardly facing surface 22 thereof, a groove 24 that is recessed relative to the remainder of the surface 22. The groove 24 of each sidewall 16,18 defines a shoulder 26 that faces the bottom of the channel member 10

The resilient deformability of the barbs 20 is in preferred embodiments of the invention greater than the deflectability of the sidewalls.

The grooves 24, provided in the sidewalls 16, 18, are mutually parallel in the embodiment shown, but this need not be so in other embodiments.

The channel member 10 is also open at each end (not shown) allowing sliding engagement of an engaging portion 28 of an accessory 30 via an end opening (FIG. 2a).

The engaging portion 28 may alternatively be push-fittingly engaged in the channel member 10 via the open side 12.

The engaging portion 28 of the accessory 30 (FIG. 2b) includes a pair of formations 32 that correspond in size, shape and location to the grooves 24 formed in the sidewalls 16, 18 of the channel member 10.

When engaged in the socket 14 of the channel member 10, the engaging portion 28 cannot be pulled through the open side 12 of the channel member 10. Pulling movement of the engaging portion 28 towards the open side 12 forces the formation 32 against the shoulder 26 of the channel member 10. Engagement between the formation 32 and the shoulder 26 prevents the formation 32 passing through the open side 12 of the channel member 10.

In another embodiment the inwardly facing surface 22 of each of the sidewalls 16, 18 of he channel member 10 (FIG. 1b) may be flat, free from any grooves. In such an embodiment, the engaging portion 28 of an accessory (not shown) may be retained in the socket 14 of the channel member 10 by, for example, glue or welding.

When the channel member 10 is inserted into a shelf front channel 34 (FIG. 2c), in a push-fit manner, engagement between the deformable barbs 20 and the shelf front channel sidewalls 36, 38 retains the channel member 10 in position. The accessory 30 is therefore retained in position relative to the shelf 40 in which the shelf front channel 34 is formed.

In embodiments of the invention, the accessory 30 may be a shelf divider 42, as shown in FIG. 3.

The shelf divider 42 of FIG. 3 includes a planar member 44 that is generally rectangular in shape. A riser 46 is secured along a first, relatively shorter edge 48 of the planar member 44 such that a free end of the riser extends from the planar member 44 in a direction parallel to the first edge 48.

The free end of the riser 46 includes an engaging portion 45, similar to the engaging portion 28 described earlier with reference to FIGS. 2a and 2b.

In other embodiments of the invention, the accessory 30 may be a bracket 72, as shown in FIG. 4a.

The bracket 72 of FIG. 4a includes a planar member 74 that is generally rectangular in shape.

The planar member 74 is connected along a first edge 76 to a first downwardly extending limb 78 of an n-shaped connecting member 82 such that the connecting member 82 extends perpendicular to the planar member 74.

A second downwardly extending limb 80 of the connecting member 82 includes an engaging portion 84 at its free end, similar to the engaging portion 28 described earlier with reference to FIGS. 2a and 2b.

In such embodiments a channel member 86, similar to the channel member 10 described with reference to FIG. 1a, engaged with the engaging portion 84 of the limb 80, may be used-to secure the-bracket 72 over a riser 88 as shown in FIG. 4b.

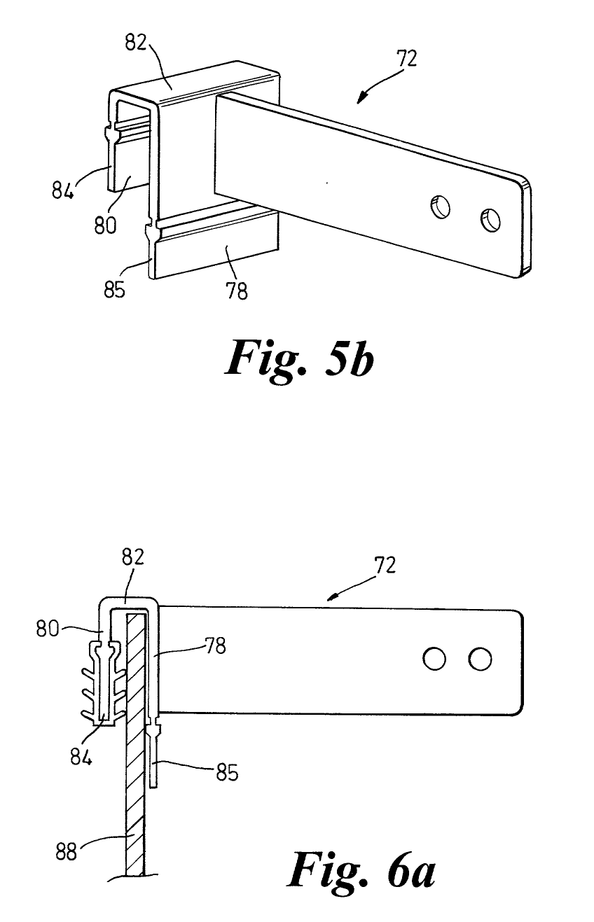

In FIG. 4b, the n-shaped connecting member 82 is fitted over an upper, free edge 90 of a riser 88, secured in a shelf front channel 88a (FIG. 5a). Riser 88 may if desired be so secured by means of one or more of the channel members 10 shown in FIGS. 1-3; or the arrangement may be as described below in relation to FIG. 7.

Barbs 92 provided on a first sidewall 94 of a channel member 86 engage a first side 96 of the riser 88.

Engagement between the barbs 92 and the first side 96 of the riser 88 retains the channel member 86 in position. The bracket 72 is therefore retained in position relative to the riser 88.

The first downwardly extending limb 78 of the connecting member 82 may also include an engaging portion 85 at its free end (FIG. 5b). In such embodiments, the first limb 78 is relatively longer than the second limb 80.

A channel member 86 engaged with the engaging portion 84 of the second limb 80 may be used to secure the bracket 72 over a riser 88 (FIG. 4b), in a similar manner to that described above with reference to FIGS. 4a and 5a.

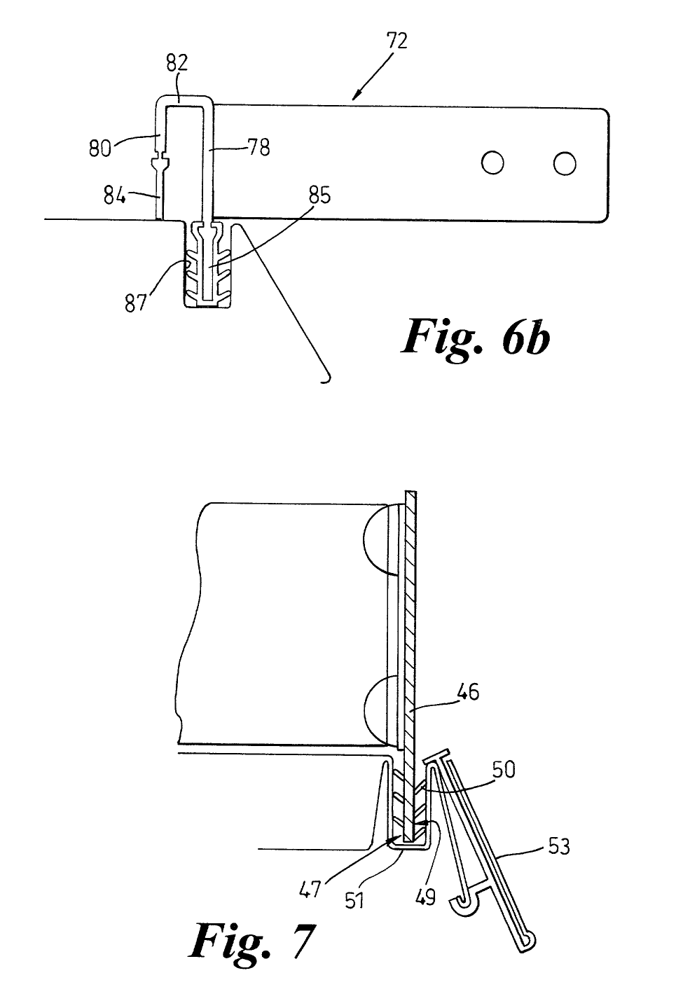

Alternatively, a channel member 86 engaged with the engaging portion 85 of the first limb 78 may be used to secure the bracket in a shelf front channel 87 (FIG. 6b) in a similar manner to that described above with reference to FIG. 2c.

The bracket 72 may be used to support a holder 98 e.g. for batteries, as shown in FIG. 5a.

The holder 98 shown in FIG. 5a includes a plurality of outwardly extending hook members 100. The holder 98 also includes an engagement member 102 located towards one end.

The engagement member 102 comprises two resiliently deflectable limbs 104, 106 that are engageable through a hole 108 provided in the planar member 74 of the bracket 72 in a snap-fit manner.

Since in the embodiment of FIGS. 4a, 4b, 5a and 6a the barbs 92 on only one side 86a of channel member 86 are used it is possible to devise, within the scope of the invention, a further embodiment of the channel member 86 omitting barbs 92 from its opposite side 86b. Nonetheless the embodiment shown is in some circumstances preferred because of its simplicity of use and manufacture.

In other embodiments, as exemplified in a non-limiting manner by FIG. 7, two opposite sidewalls 47, 49 of the free end of the riser 46 may include at least two resiliently deformable, mutually parallel barbs 50 protruding therefrom.

The provision of the barbs 50 allows the free end of the riser 46 to be push fittingly engaged in a shelf front channel 51, as shown in FIG. 7.

FIG. 7 also shows in exemplary fashion a shelf front extrusion 53 that may if desired be formed integrally with channel 51.

Other retail accessory assemblies, similar to the divider assembly shown in FIG. 7, are shown in FIGS. 8 to 11.

FIG. 8 shows a leaflet dispenser 52 cantilevered from one end of a riser 54; FIG. 9 shows a point of sale cardholder 56 secured to one end of a riser 58; FIG. 10 shows a bracket 60 secured to one end of a right-angled riser 62 and FIG. 11 shows another bracket 64 bolted to one end of a riser 66. FIGS. 10 and 11 show in exemplary fashion the brackets 62, 64 secured respectively to a tester bottle holder (FIG. 10) and a tray (FIG. 11).

In the embodiments of FIGS. 8 to 11, each of the risers 54; 58; 62; 66 includes a plurality of resiliently deformable, mutually parallel barbs 68, protruding from opposite sides of its free end.

As in the embodiment shown in FIG. 7, the barbs 68 allow push-fitting engagement of the free end of each of the risers 54; 58; 62; 66 in a shelf front channel 70.

In other embodiments, as exemplified in a non-limiting manner by FIG. 12a, a plate 140 includes at least two resiliently deformable, mutually parallel barbs 142 protruding from one side thereof.

The plate 140 may be secured to, for example, the free end of a riser 144 of an accessory (not shown) by, for example, glue or welding.

The provision of the barbs 142 allows the free end of the riser 144 to be push-fittingly engaged in a shelf front channel 146.

The riser 144 may be provided with one such plate 140 secured to one sidewall, as shown in FIG. 12a, orO the riser 144 may be provided with two such plates 140a, 140b secured to opposing sidewalls, as shown in FIG. 12b.

In yet further embodiments, the or each plate 140 may include, on an inwardly facing surface 148 thereof, a groove 150 that is recessed relative to the remainder of the surface 148.

In use, the groove 150 may engage a formation 152 (FIG. 12c) that corresponds in size and shape to the groove 150, preventing relative movement of the plate 140 along the length of the riser 144. Such engagement may mean that it is not necessary to use, for example, glue or welding to secure the plate 140 relative to the riser 144.

In another embodiment, the plate 140 may include a slot 154 (FIG. 12d) that is form-lockingly engageable with a pair of members 156, 158 protruding from a sidewall of a riser 144.

Referring now to FIG. 13 there is shown another embodiment 110 of channel member according to the invention. Channel member 110 is similar to member 10, apart from the modifications disclosed hereinbelow.

The hollow interior 111 of channel member 110 is substantially parallel sided, but the open, upper side 112 thereof is narrower than interior 111. This results in a downwardly facing shoulder 113 at either side of the top of interior 111.

An accessory such as extrusion 114 includes a generally planar riser 116 15 having a “waist” 117 of reduced thickness. On pushing of riser 116 into interior 111 via open side 112 the portion 118 of riser 116 below waist 117 pushes the sidewalls 119, 120 of channel member 110 apart until waist 117 snaps into engagement with the underside of the shoulders 113. The resilient deformability of the sidewalls 119, 120 then secures the accessory 114 and channel member 110 together. Channel member 110 may then be used as shown in FIG. 14 to retain the accessory 114 relative to a shelf front channel 121.

FIG. 15 shows a prior art extrusion previously proposed for the purpose exemplified by channel member 110. In FIG. 15 the extrusion 114 includes integral therewith a laterally deformable, resilient leaf spring 114a. Because of variability of the widths of channels 121 as shown in FIG. 14 the leaf spring 114a sometimes tends to work the accessory out of the channel 121. The arrangement of FIGS. 13 and 14 solves this disadvantage.

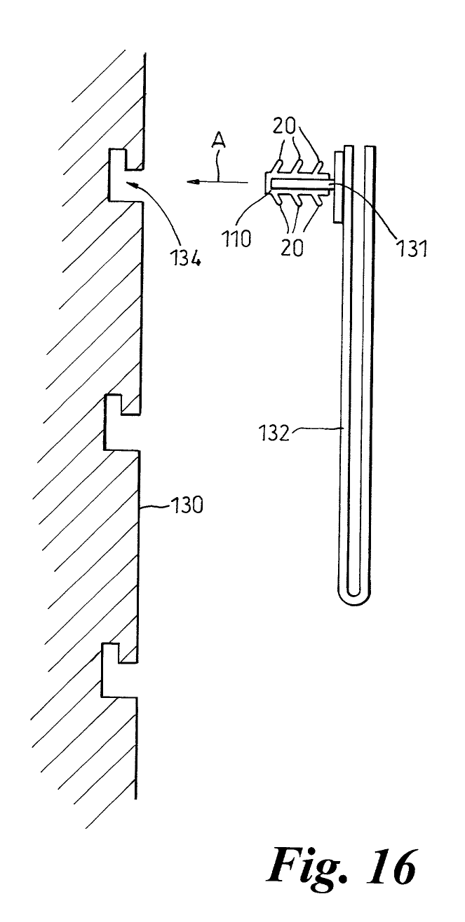

FIGS. 16-20 show use (in accordance with the invention) of a channel member, that may be according to any of the embodiments disclosed herein, to support accessories from a slat wall 130. For convenience FIGS. 16-20 show a channel member such as channel member 110 of FIG. 13.

FIG. 16 shows a channel member 110 having secured therein by the mechanism illustrated in FIG. 13 a T-shaped bracket 131 that is itself rigidly secured to the rear face of a poster or card holder 132.

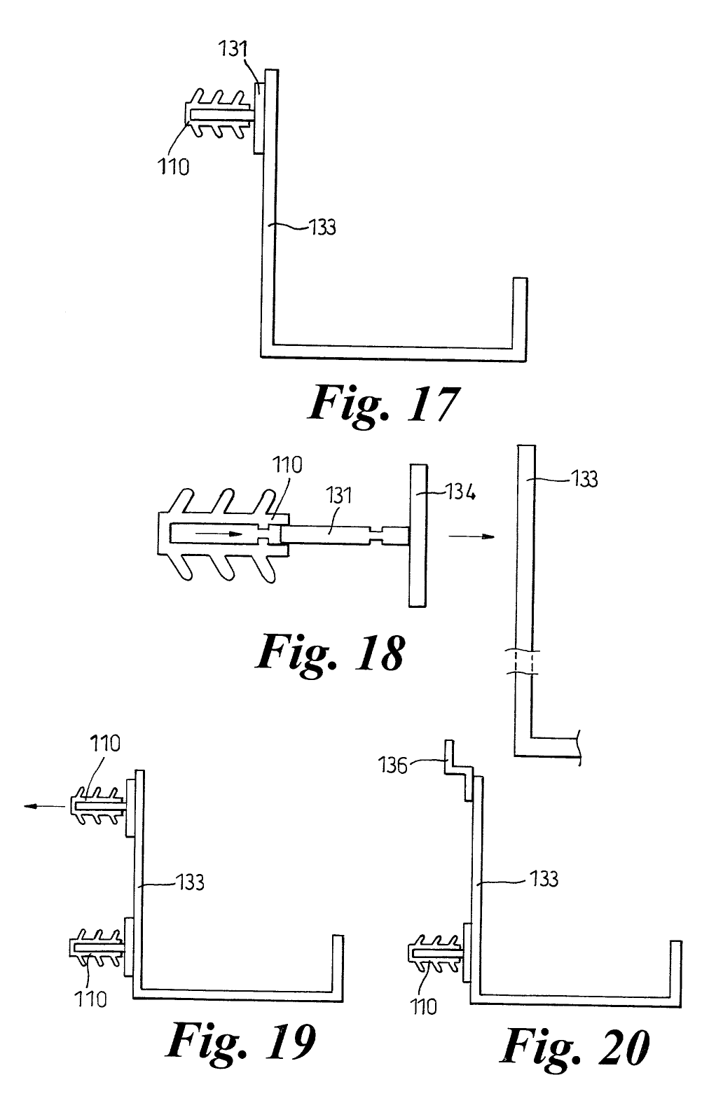

Another exemplary embodiment is shown in FIG. 17, in which bracket 131 is secured to the rear face of an L-shaped shelf 133. Other accessories may of course be used instead of those shown.

The components of FIG. 17 are in FIG. 18 shown separated from one another. Face 134 of bracket 131 may be secured to shelf 133 e.g. by gluing or welding.

Regardless of the precise accessory chosen, it may be firmly secured to slat wall 130 by pushing member 110 horizontally into a slat spacing 134 as illustrated by arrow A in FIG. 16.

Although the channel member 110 when inserted does not occupy the entire cross section of the L-shaped slat spring 134, nonetheless the resiliently deformable barbs 20 are sufficient firmly to retain the accessory.

This arrangement offers the following advantages over conventional, cranked slat hooks (such as hook 136 visible in FIG. 20):

1. Conventional slat hooks require upward tilting of the accessory during assembly of a display, in order to achieve the entry angle needed to permit the slat hook to engage the slat spacing. This means that a shopfitter must leave a significant gap above each accessory.

In contrast the horizontal push-fit action of the channel member 110 obviates the need for such tilting, and hence for such a gap. This leads to more efficient use of slat wall space.

2. Conventional slat wall hooks tend to tilt upwardly when knocked from below, causing untidiness of displays.

The channel member 110 of the invention can only move horizontally relative to the slat spacings, thereby obviating this problem.

Of course it is possible to device a “channel wall” having U-shaped channels (instead of the L-shaped slat spacings 134 shown) for receiving the channel members 110.

FIGS. 16-18 therefore illustrate only one of several modes of horizontal insertion of the channel members 110.

As exemplified by FIG. 19 it may be desirable in some arrangements to employ two or more of the channel members 110 supporting the shelf 133 via a pair of the brackets 131.

Alternatively, as shown in FIG. 20 the channel members 110 may be used in combination with one or more conventional slat wall hooks 136.

Although the embodiments shown in FIG. 14 and 16 to 20 employ channel member 110 of FIG. 13, it is also within the scope of the invention to employ the channel member 10 of FIGS. 1a and 1b in each of these embodiments.

FIGS. 21 to 23 show yet a further variant within the scope of the invention.

The arrangement of FIGS. 21 to 23 is similar to the FIG. 5 embodiment, except that the connecting member 82′ includes secured thereto a socket 74′ instead of the member 74.

Socket 74′ is elongate and includes at its end remote from bracket 82 an opening for receiving a free end of an arm 74″.

Arm 74″ may take any of a number of forms, within the scope of the invention.

In the embodiment of FIGS. 21 and 22, that show components respectively in exploded and assembled view, arm 74″ is essentially a rectangular plate that may be manufactured eg. from PET or polycarbonate.

At its free ends arm 74″ includes ribs 271 upstanding from its surface in order to provide friction retention of the ends of arm 74″ in sockets such as socket 74′. The dimensions of the ends of the arm and the socket opening are of course chosen to facilitate releasable securing of the socket and arm together.

Intermediate its free ends arm 74″ includes a deepened portion 272 juxtaposed next to a tongue 273. These components define a card or ticket holder.

At its end remote from socket 74′ arm 74″ may optionally have secured thereto a hook 273 defining a hollow socket into which arm 74″ is insertable to permit hanging of a further retail display item 276 from arm 74″.

Arm 74″ may be any of a range of lengths and sizes.

The dismanteable nature of the embodiment of FIGS. 21 and 22 permits replacement of the connecting member 82′ and gripper member 86 by a peg hole shelf attachment 277 of the general kind shown in FIG. 23.

The precise details of attachment 277 may of course be varied. For example the socket thereof is in other embodiments replaceable by eg. a permanently secured arm.

1. A channel member open on one side to define a socket for receiving a retail or display accessory, the exterior of one or more walls of the channel member including resiliently deformable ribs protruding therefrom to permit retention of the channel member in a recess formed in a structure.

2. A channel member according to claim 1 wherein the ribs include at least two mutually parallel barbs protruding from each of a pair of said walls.

3. A channel member according to claim 1 or claim 2 wherein one or more sidewalls of the channel member are resiliently deflectable, one or more of said sidewalls including on an inwardly facing surface a formation that is co-operable with a correspondingly shaped formation formed on a retail or display accessory to define a detent for retaining the retail accessory in the socket.

4. A channel member according to claim 3 wherein two said sidewalls are resiliently deflectable and the formation on each said surface is a groove that is recessed relative to the remainder of the surface and defines a shoulder facing the bottom of the channel to define the detent.

5. A channel member according to claim 4 wherein the said grooves are mutually parallel.

6. A channel member as claimed in any preceding claim wherein the channel member and the barbs are co-extruded respectively from different grades of polyvinylchloride.

7. A retail or display accessory assembly, suitable for engagement in a channel formed in a structure comprising:
a retail or display accessory including a connecting member; and
a channel member according to any preceding claim, wherein said connecting member is secured to, and extends from, said accessory and is inserted into the socket defined by the channel member.

8. A retail or display accessory assembly comprising a retail or display accessory including a riser, the exterior of one or more sidewalls of the riser having secured thereto resiliently deformable ribs protruding therefrom to permit retention of the riser in a channel formed in a structure.

9. A retail or display accessory assembly as claimed in claim 7 or claim 8 wherein said accessory is a point of sale cardholder, divider, bracket, leaflet dispenser, sample dispenser, wobbler, shelf, poster holder or pendant.

10. A retail or display accessory having protruding therefrom a connecting member, two opposite sidewalls of the connecting member each including a formation that is co-operable with a correspondingly shaped formation formed in a socket of a channel member.

11. A channel member generally as herein described with reference to and/or as illustrated in FIGS. 1, 2a, 2c, 4 to 6, 12 to 14 and 16 to 20 of the accompanying drawings.

12. A retail or display accessory assembly generally as herein described with reference to and/or as illustrated in FIGS. 2a to 2c, 4 to 14 and 16 to 20 of the accompanying drawings.

13. A retail or display accessory generally as herein described with reference to and/or as illustrated in FIG. 3 of the accompanying drawings.

14. Use of a channel member according to any of claims 1-6 to secure an article relative to a channel.

15. Use according to claim 14 wherein the channel is a shelf front channel.

16. Use according to claim 14 wherein the channel is a slat wall channel or spacing.
